(19) United States
(12) Patent Application Publication
(10) Pub. No.: US 2026/0066658 A1
(43) Pub. Date: Mar. 5, 2026

(54) LARGE-SCALE BATTERY ENERGY STORAGE SYSTEM SITING AND SIZING FOR PARTICIPATION IN WHOLESALE ENERGY MARKET USING HYPERPARAMETER OPTIMIZATION

(71) Applicant: Siemens Corporation, Iselin, NJ (US)

(72) Inventors: Ang Li, Houston, TX (US); Yubo Wang, Princeton, NJ (US); Siddharth Bhela, Princeton Junction, NJ (US)

(73) Assignee: Siemens Corporation, Washington, NJ (US)

(21) Appl. No.: 19/103,264

(22) PCT Filed: Aug. 24, 2022
(86) PCT No.: PCT/US2022/041302

§ 371 Date: Feb. 12, 2025

(51) Int. Cl. H02J 3/32; H02J 3/00

(52) U.S. Cl. CPC H02J 3/32; H02J 3/004; H01M 2220/10; H02J 2103/30

(57) ABSTRACT

According to a method to aid installation of large-scale BESS in a power network, a hyperparameter optimization engine generates a feasible configuration of BESS defined by location and sizing parameters subject to an installation constraint. A power system simulation engine conducts an energy market simulation for the power network with the generated configuration over a defined simulation horizon to determine a configuration value. The power system simulation engine comprises one or more subroutines characterizing the impact of the BESS on the market clearing mechanism, to compute an expected generation cost associated with the BESS. The configuration value is determined based on the expected generation cost and a total installation cost of the BESS. The hyperparameter optimization engine is iteratively executed to generate an updated configuration based on the configuration values of previous configurations, to determine a final configuration of BESS defined by a set of optimal location and sizing parameters.

### TECHNICAL FIELD

The present disclosure relates to the determination of optimal siting and sizing of large-scale battery energy storage systems in a power network for generating electricity for a wholesale energy market.

### BACKGROUND

In power networks, a number of energy market participants may generate electricity that may be distributed over common transmission lines to residential, commercial and industrial customers. Electricity may be generated via generating units that may include thermal power plants (e.g., gas turbines, steam turbines, combined cycle power plants, etc.), renewable energy sources (e.g., wind turbines, solar panels, etc.). Energy storage systems (e.g., batteries, compressed air storage, pumped hydro storage, etc.) can discharge the previously stored energy and act as generation units.

Battery energy storage systems (BESS) comprise re-chargeable batteries, which are electro-chemical devices that can charge or collect energy from a power network, and subsequently discharge that energy at a later time to provide electricity to the power network when needed. BESS can also include power electronic inverters to couple the batteries to the power network. A common reason for installing BESS in power networks is to alleviate the challenges of uncertainty and variability associated with renewable energy sources.

In a wholesale energy market, a generating unit may be operated via a clearing mechanism based on economic dispatch, which aims to maximize social welfare by minimizing overall cost while meeting the grid limitations. The overall cost can depend on the cost of electricity generation by the individual generating units (bidding price), and in many cases, also the cost incurred by the transmission losses and congestion.

The cost of electricity in a power network may depend on the siting (i.e., location) in the power network. Accordingly, the pricing of electricity in the energy market may be defined by a locational marginal price (LMP). Hence, for a participant of the energy market to invest in new BESS, the siting and sizing of the BESS can be of crucial importance to their value for the BESS owner. However, unlike small-scale BESS which may have little or no impact on the clearing mechanism, large-scale BESS do impact the LMP of electricity, thereby impacting the clearing mechanism. The above can pose a major computational challenge when determining an optimum siting and sizing of large-scale BESS.

### SUMMARY

Briefly, aspects of the present disclosure address at least the above-described technical problem by providing a computer-implemented technique to aid installation of large-scale BESS in a power network for generating electricity for an energy market based on economic dispatch.

A first aspect of the disclosure provides a computer-implemented method to support installation of new BESS in a power network. The method comprises executing a hyperparameter optimization engine for generating a feasible configuration of BESS defined by a set of location and sizing parameters subject to an installation constraint. The method further comprises executing a power system simulation engine for simulating an energy market for the power network with the generated configuration over a defined simulation horizon to determine a configuration value. The execution of the power system simulation engine comprises, via a first simulator, solving an economic dispatch problem to minimize a total generation cost in the power network using bidding parameters associated with the BESS computed via a second simulator, to therefrom compute a LMP at multiple locations in the power network. The execution of the power system simulation engine further comprises, via a second simulator, solving a BESS scheduling problem to minimize a generation cost associated with the BESS using the LMP computed via the first simulator, to therefrom compute the bidding parameters associated with the BESS. The execution of the power system simulation engine further comprises iteratively updating the first simulator with the bidding parameters computed via the second simulator and updating the second simulator with the LMP computed via the first simulator to converge on an expected generation cost associated with the BESS. The configuration value is determined based on the expected generation cost associated with the BESS and a total installation cost associated with the BESS. The hyperparameter optimization engine is executed over a number of iterations to generate, at each iteration, an updated configuration based on the configuration values of previous configurations, to determine a final configuration of BESS defined by a set of optimal location and sizing parameters.

Other aspects of the present disclosure implement features of the above-described methods in computing systems and computer program products to support installation of large-scale BESS in a power network

Additional technical features and benefits may be realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The foregoing and other aspects of the present disclosure are best understood from the following detailed description when read in connection with the accompanying drawings. To easily identify the discussion of any element or act, the most significant digit or digits in a reference number refer to the figure number in which the element or act is first introduced.

FIG. 1 is a schematic diagram illustrating an example of a portion of a transmission network where large-scale BESS may be installed in accordance with aspects of the present disclosure.

FIG. 2 is a schematic block diagram of a system for determining optimal siting and sizing of large-scale BESS to be installed in a power network.

FIG. 3 illustrates a computing system that can support installation of large-scale BESS in a power network.

### DETAILED DESCRIPTION

Electricity may be bought, sold and traded in wholesale and retail energy markets. Typically, in a wholesale energy market, an independent system operator (ISO) may collect energy offers and bids from energy generating resources (energy market participants), and dispatch electricity using a market clearing mechanism based on economic dispatch. “Economic dispatch” refers to the operation of generating units to produce energy at the lowest cost to reliably serve consumers, recognizing any operational limits of generation and transmission facilities. If a resource submits a successful bid and will therefore be contributing its generation to meet demand, it is said to “clear” the market. The cheapest resource will “clear” the market first, followed by the next cheapest option and so forth until demand is met. When supply matches demand (load), the market may be “cleared”. Market clearing may occur periodically (e.g., every 5 mins) and market bids may change over time, adapting to demand and generation fluctuations.

By solving the economic dispatch problem, a locational marginal price (LMP) of electricity may be determined at multiple locations in the power network. The locations may be defined by nodes of the power network. A node may be defined as a point in a power network where supply enters the power system. A node may thus refer to a generator busbar, a transmission intertie or a load takeout point. LMP at a location (node) may be defined as a marginal cost of supplying an additional increment of load at that location without violating security and/or transmission limits.

For an energy market participant to invest in new BESS in the power network, the siting (i.e., location) and sizing of the BESS can be of crucial importance to their value for the BESS owner. However, unlike small-scale BESS which may have little or no impact on the clearing mechanism, large-scale BESS do impact the LMP, thereby impacting the clearing mechanism. This can pose a major computational challenge when determining an optimum siting and sizing of large-scale BESS.

Before undertaking a detailed description of the disclosed methodology, it may be beneficial to establish the following definitions:

### Index Sets

I: Set of locations of BESS. (Indexed by i).
B: Set of nodes of the power network. (Indexed by b).
T: Time horizon of study. (Indexed by t).
L: Set of lines of the power network. (Indexed by l).

### Superscripts

c: Refers to battery charging.
d Refers to battery discharging.

### Parameters

$${α}_{i}^{c} , {α}_{i}^{d} :$$

Bidding parameters representing cost of battery charging/discharging at location i.

$${P}_{it}^{c , l} , {P}_{it}^{c , u} :$$

Bidding parameters representing minimum and maximum battery charging rate limits at location i at time t.

$${P}_{it}^{d , l} , {P}_{it}^{d , u} :$$

Bidding parameters representing minimum and maximum battery discharging rate limits at location i at time t.
Gᵢ: Cost of installation per unit battery capacity at location i.
SF Shift factor or power transfer distribution factor of a power network. The matrix SF is a linear mapping between the power injection on each node and the power flow on each transmission line.
FL Power flow capacity (limit) on each transmission line.
κ^{c}, κ^{d}: Power limit coefficients, defined by a ratio between battery charging/discharging power limit and battery capacity.

$${γ}_{i}^{c} , {γ}_{i}^{d} :$$

Inverter installation cost coefficient for charging/discharging at location i. Inverter installation cost is proportional to power limit coefficient and battery capacity.
SOC^{l}, SOC^{u}: Lower and upper operational bounds of battery state of charge (SOC) percentage.
η: Battery charging/discharging efficiency.
Δ_{T}: Time resolution of study.
U: Total budget.

### Decision Variables

$${p}_{it}^{c} :$$

Battery charging power at location i at time t.

$${p}_{it}^{d} :$$

Battery discharging power at location i at time t.
cᵢ: Battery capacity at location i.
eᵢₜ: Battery energy level location i at time t.

In the present description, a battery energy storage system or BESS is understood to include at least one battery and an inverter.

Based on the above definitions, a mathematical model for the problem that the disclosed methodology can solve may be summarized as follows.

$$min {\sum }_{i} {\sum }_{t} {α}_{i}^{c} {p}_{it}^{c} + {α}_{i}^{d} {p}_{it}^{d} + {\sum }_{i} {G}_{i} {c}_{i} + {\sum }_{i} ( {γ}_{i}^{c} {κ}^{c} + {γ}_{i}^{d} {κ}^{d} ) {c}_{i} + other costs \qquad ( 1 )$$

$$s . t . {\sum }_{i ∈ I} {p}_{it}^{c} - {p}_{it}^{d} - other generating units + other loads = 0 \qquad ( 2 )$$

$$- {FL}_{l} \leq {\sum }_{b} {SF}_{lb} ( {\sum }_{i ∈ {I}_{b}} {p}_{it}^{c} - {p}_{it}^{d} - other generating units + other loads ) \leq {FL}_{l} \qquad ( 3 )$$

$$0 \leq {p}_{it}^{c} \leq {κ}^{c} {c}_{i} , 0 \leq {p}_{it}^{d} \leq {κ}^{d} {c}_{i} , {SOC}_{t}^{l} {c}_{i} \leq {e}_{it} \leq {SOC}_{t}^{u} {c}_{i} , \\ {e}_{i , t + 1} = {e}_{it} + {p}_{it}^{c} {η}^{c} {Δ}_{T} - \frac{{p}_{it}^{d}}{{η}^{d}} {Δ}_{T} , \qquad ( 4 )$$

$${\sum }_{i} {G}_{i} {c}_{i} + {\sum }_{i} ( {γ}_{i}^{c} {κ}^{c} + {γ}_{i}^{d} {κ}^{d} ) {c}_{i} \leq U \qquad ( 5 )$$

In the above-described model, equation (1) defines an economic dispatch problem, where the term

$${α}_{i}^{c} {p}_{it}^{c} + {α}_{i}^{d} {p}_{it}^{d}$$

defines a total generation cost associated with new BESS to be installed, the term ΣᵢGᵢcᵢ defines a battery capacity installation cost of the new BESS, the term

$${\sum }_{i} ( {γ}_{i}^{c} {κ}^{c} + {γ}_{i}^{d} {κ}^{d} ) {c}_{i}$$

defines an inverter size installation cost of the new BESS, and the term other costs covers costs of other generating units, including existing BESS. Equation (2) defines a power balance constraint based on equality of power demand and supply. Equation (3) defines a constraint posed by line power flow limits (in this formulation, for a transmission line). Equations (4) define constraints on battery charging rate, battery discharge rate and energy level. Equation (5) defines a total installation cost constraint.

According to the above-described model, the LMP of the energy market can be defined by the dual variables to equations (2), (3). Specifically, let λ₀ the dual variable to equation (2) and let π⁺, π⁻. It be the dual variables to equation (3) respectively, then the LMP vector can be defined by λ=λ₀+SF^{T}(π⁺−λ⁻), where SF^{T} is the transpose of the matrix SF. The BESS owner may submit their bidding strategy, defined by bidding parameters α^{c}, α^{d} and power rate limits to the ISO based on the market price A, denoted by {α^{c}, α^{d}}=π(λ). Therefore, in the case of large-scale BESS that impact the LMP, the primal problem is entangled with the dual variables. The implicit involvement of dual variables may pose a major challenge to solving the optimization problem.

Strategic investments of small-scale BESS have been studied. However, optimal siting and sizing problems for large-scale BESS are typically intractable because large-scale BESS can have an impact on the LMP, as shown above. This factor can significantly increase the computational complexity of the optimization problem. The convergence and existence of effective algorithms remain open questions for the above-described model, since it involves dual variables in an entangled formulation.

The disclosed methodology can be used to determine optimal siting and sizing for installing large-scale BESS in a power network for generating electricity for an energy market based on economic dispatch. The disclosed methodology may be suitably implemented by a BESS owner that plans to install BESS to bid into the wholesale energy market to generate revenue.

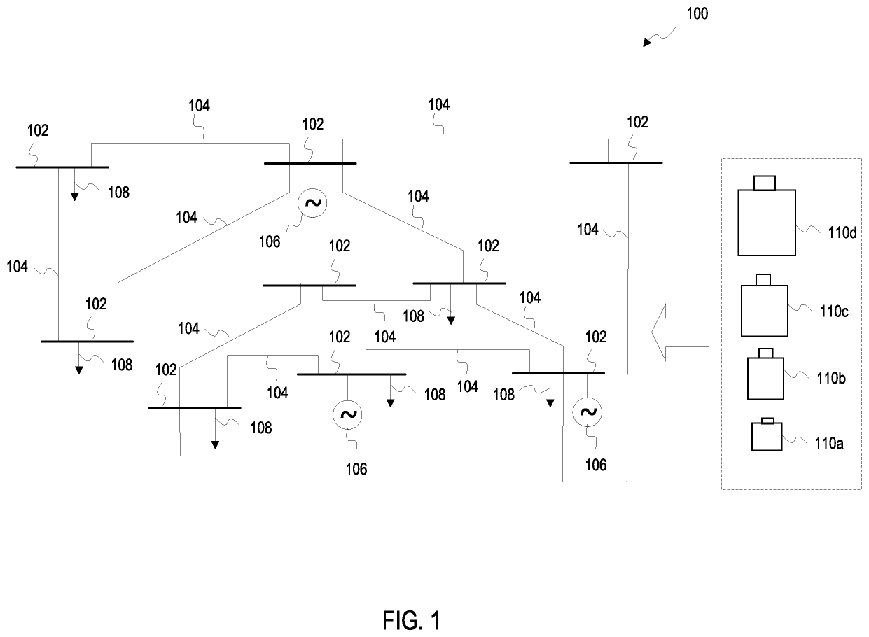

Turning now to the drawings, FIG. 1 shows an example of a power transmission network 100 where optimal siting and sizing of large-scale BESS can be determined in accordance with the disclosed methodology. The illustrated power network 100 comprises nodes (e.g., buses) 102 connected to branches (e.g., transmission lines) 104 in a loopy topology. The shown topology of the power network is illustrative and simplified. The disclosed methodology is not limited to any particular type of network topology and can be applied to power networks comprising several nodes and branches. As shown, some of the nodes 102 may have generating units 106 and/or loads 108 connected to them while others may have no power consumption or injection (zero-injection nodes). The generating units 106 may comprise, for example, thermal generating units (e.g., gas turbines, steam turbines, combined cycle power plants, etc.), renewable energy sources (e.g., wind turbines, solar panels, etc.) and energy storage systems (e.g., batteries, compressed air storage, pumped hydro storage, etc.).

To adapt the power network 100 to a long-term increase in load and/or generated power fluctuation and manage transmission line congestion, it may be desirable to install BESS of various sizes (schematically denoted as 110a, 110b, 110c, 110d) at one or more locations in the power network 100. The location of a BESS may be defined by a node 102 of the power network 100. The size of a BESS may be defined in terms of sizing parameters, which may include, for example, battery capacity and/or inverter size. Aspects of the present disclosure provide a technical solution for supporting BESS owners, such as utility companies, to determine optimal siting and sizing of large-scale BESS to be installed to a power network, subject to underlying installation constraints, to maximize revenue generated from these assets.

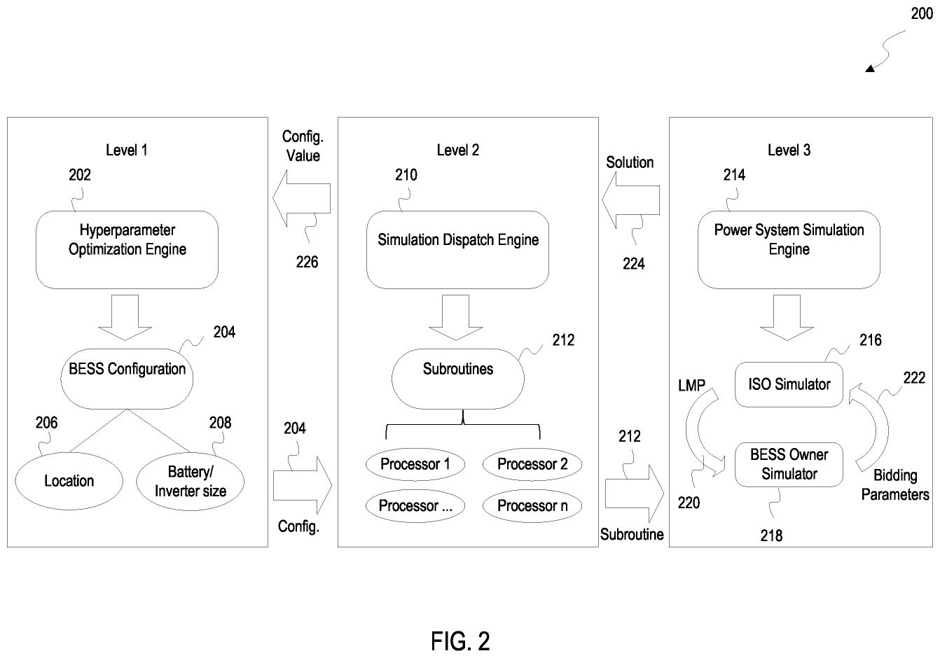

FIG. 2 illustrates a system 200 for determining optimal siting and sizing of large-scale BESS to be installed in a power network according to disclosed embodiments. The various engines described herein, including the hyperparameter optimization engine 202, the simulation dispatch engine 210 and the power system simulation engine 214, may be implemented by a computing system in various ways, for example, as hardware and programming. The programming for the engines 202, 210 and 214 may take the form of processor-executable instructions stored on non-transitory machine-readable storage mediums and the hardware for the engines may include processors to execute those instructions. The processing capability of the systems, devices, and engines described herein, including the hyperparameter optimization engine 202, the simulation dispatch engine 210 and the power system simulation engine 214, may be distributed among multiple system components, such as among multiple processors and memories, optionally including multiple distributed processing systems or cloud/network elements.

As shown in FIG. 2, the disclosed embodiments are based on a tiered approach. A first computational level (level 1) involves executing a hyperparameter optimization engine 202 for generating feasible BESS configurations 204 subject to one or more installation constraints. The installation constraint(s) can include, for example, a total budget (U) defining a maximum total installation cost associated with the BESS. In one embodiment, the total installation cost associated with the BESS may be determined based on sum of a battery capacity cost ΣᵢGᵢcᵢ and an inverter size cost

$${\sum }_{i} ( {γ}_{i}^{c} {κ}^{c} + {γ}_{i}^{d} {κ}^{d} ) {c}_{i} ,$$

as expressed in equation (5). Other examples of constraints can include maximum number of BESS installation locations, maximum battery capacity and/or inverter size, etc.

Each BESS configuration 204 generated by the hyperparameter optimization engine 202 may be defined by a set of optimizable parameters (referred to as “hyperparameters”), that include location parameters 206 and sizing parameters 208 of BESS to be installed. Since the location parameters 206 and the sizing parameters 208 determined at level 1 remain fixed at level 2 and level 3, they are referred to as hyperparameters. The location parameters 208 may define a set (I) of one or more locations (e.g., nodes) for installation of the BESS. The sizing parameters 208 may include a battery size at respective BESS locations defined by battery capacity (cᵢ). Additionally, or alternately, the sizing parameters 208 may include an inverter size at respective BESS locations. Inverter size can limit the battery charging and discharging rate and may be used as an optimizable parameter since this can affect a bidding strategy of the BESS owner. For example, if a higher charging/discharging rate is desired, it may be more expensive to obtain because it may necessitate a bigger inverter size. According to disclosed embodiments, the inverter size may be defined by power limit coefficients, that include a first coefficient (κ^{c}) indicative of a ratio between a battery charging power limit and battery capacity and a second coefficient (κ^{d}) indicative of a ratio between a battery discharging power limit and battery capacity. In one embodiment, a BESS configuration 204 may be represented by a vector representation characterizing each node of the power network with sizing values of BESS to be installed, where nodes without BESS may be padded with “zero” sizing values.

The hyperparameter optimization engine 202 may be configured to iteratively generate successive BESS configurations 204 by tuning the hyperparameters 206, 208 to maximize a configuration value 226. The configuration value 226 of a BESS configuration 204 may be determined, for example, by evaluating an expected long-term cost or profit generated by the BESS configuration 204.

The problem solved by the hyperparameter optimization engine 202 may take the form

$${max}_{x ∈ A} f ( x ) ,$$

where x denotes the set of hyperparameters that define a BESS configuration, A denotes the feasible set of hyperparameters that satisfy the installation constraint(s), ƒ denotes the objective function, and ƒ(x) denotes the configuration value 226. The function ƒ can take the form of an unknown structure (“black box”) and may be evaluated to determine the configuration value 226 by running power system simulations for simulating an energy market for the power network with the generated BESS configuration 204 over a defined simulation horizon, based on execution of level 2 and level 3 as described in detail below. Because of the computational complexity associated with performing the long-term energy market simulation, the configuration value 226 defined by ƒ(x) may typically be expensive (i.e., computational resource intensive) to evaluate.

According to disclosed embodiments, the hyperparameter optimization engine 202 may include a Bayesian optimization engine. Bayesian optimization has been used for tuning hyperparameters of machine learning algorithms, for example, as described in the document: Snoek, Jasper; Larochelle, Hugo; Adams, Ryan (2012). “Practical Bayesian Optimization of Machine Learning Algorithms”. Advances in Neural Information Processing Systems. For the present application, a Bayesian optimization framework may be adapted as follows. First, an initial set of BESS configurations 204 (defined by hyperparameters 206, 208) may be sampled to evaluate the corresponding configuration values 226 by performing the long-term energy market simulation on those BESS configurations 204 based on execution of level 2 and level 3. The initial set of BESS configurations 204 may be sampled using known techniques, such as random crop sampling, Latin hypercube sampling, etc. The sampled initial set of BESS configurations 204 and the corresponding evaluated configuration values 226 may then be used to start training of a Gaussian process regressor. The Gaussian process regressor may comprise a set of tunable regression functions with different kernels that defines a model representing the objective function ƒ. The Gaussian processor regressor may be used to calculate an acquisition function (e.g., expected improvement). Subsequent BESS configurations 204 may be generated by tuning the hyperparameters 206, 208 to update the Gaussian process regressor in a direction to maximize the acquisition function by successively evaluating, at each step, the respective configuration values 226 by performing the long-term energy market simulation based on execution of level 2 and level 3.

A Bayesian optimization engine can provide an efficient optimization framework to achieve convergence in fewer evaluations, thereby enhancing computational performance and making it particularly suitable for the present application. Other embodiments of the hyperparameter optimization engine 202 may include grid search engines, random search engines, gradient based optimization engines, evolutionary optimization engines, among others. In one embodiment, a topological embedding heuristic is used to encode the location configuration so that no integer variable is introduced in the optimization framework. This feature may reduce the computational complexity, making it possible to conduct long-term simulations covering more scenarios.

Still referring to FIG. 2, a second computational level (level 2) involves executing a simulation dispatch engine 210 for decomposing the simulation horizon into a number of intervals to generate simulation subroutines 212 corresponding to the respective intervals, for a fixed BESS configuration 204. In an example implementation, the simulation horizon may be 10 years, which can be decomposed by the simulation dispatch engine 210 into 24-hour intervals, to generate 3,650 simulation subroutines 212. As shown, the simulation subroutines 212 may be assigned to respective processors or processor cores of a multi-core CPU. Thereby, each of the simulation subroutines 212 may be independently processed in parallel at level 3, to determine an expected generation cost associated with the BESS (as per the BESS configuration 204 obtained from level 1) for each interval, to therefrom determine the configuration value 226 over the entire simulation horizon.

Decomposing the long-term simulation horizon into independent simulation subroutines for smaller intervals can suitably reduce the complexity and time associated with performing a long-term energy market simulation, making it possible to conduct long-term simulations covering a large number of scenarios. However, in some embodiments, depending on the available processing capability, level 2 may not be executed and the simulation dispatch engine 210 may be obviated.

As shown in FIG. 2, the system 200 may further include a power system simulation engine 214 that can be used to perform a long-term wholesale energy market simulation for the power network with the generated BESS configuration 204 over a defined simulation horizon, for determining the configuration value 226 of the generated BESS configuration 204. The power system simulation engine 214 may simulate realistic demands using actual historical load data of the power network for the horizon being simulated. The load data may comprise a temporal sequence of energy consumptions assigned to a set of nodes of the power network. The temporal sequence may be defined by a time resolution (Δ_{T}), which can be, for example, 1 hour. According to the disclosed embodiments, the power system simulation engine 214 may be executed at a third computational level (level 3), based on the simulation subroutines 212 created by the simulation dispatch engine 210. In this case, each simulation subroutine 212, which corresponds to a particular interval (e.g., 24 hours) of the simulation horizon (e.g., 10 years), may be independently executed by the power system simulation engine 214 as described below.

The power system simulation engine 214 may include a first simulator, referred to as an ISO simulator 216, and a second simulator, referred to as a BESS owner simulator 218. For each simulation subroutine 212, the ISO simulator 216 and the BESS owner simulator 218 can be executed iteratively to solve two optimization problems that depend on each, to identify an optimal solution 224 for the interval covered by the respective simulation subroutine 212.

The ISO simulator 216 may be executed to solve an economic dispatch problem to minimize a total generation cost in the power network, to therefrom compute the LMP 220 of the energy market. For a fixed BESS configuration 204, the economic dispatch problem may be simplified as follows:

$$min {\sum }_{i} {\sum }_{t} {α}_{i}^{c} {p}_{it}^{c} + {α}_{i}^{d} {p}_{it}^{d} + other costs \qquad ( 6 )$$

$$s . t . constraints in Eq . ( 2 ) , ( 3 ) ,$$

$${P}_{it}^{c , l} \leq {p}_{it}^{c} \leq {P}_{it}^{c , u} , {P}_{it}^{d , l} \leq {p}_{it}^{d} \leq {P}_{it}^{d , u} \qquad ( 7 )$$

For solving the above-described economic dispatch problem, the ISO simulator 216 may use bidding parameters 222 that are computed via the BESS owner simulator 218. The bidding parameters 222 may include

$${α}_{i}^{c} and {α}_{i}^{d} ,$$

which respectively represent the cost of battery charging and discharging at location i, that are used to determine the total generation cost in the power network according to equation (6).

In some scenarios, it may be desirable for a BESS owner to specify the maximum and minimum battery charging/discharging rate limits, instead availing the maximum and minimum battery charging/discharging rates allowed by the BESS equipment. Accordingly, in one embodiment, the bidding parameters 222 may additionally include

$${P}_{it}^{c , l} , {P}_{it}^{c , u} and {P}_{it}^{d , l} , {P}_{it}^{d , u} .$$

### Here.

$${P}_{it}^{c , l} , {P}_{it}^{c , u}$$

respectively represent minimum and maximum battery charging rate limits at location i at time t, and

$${P}_{it}^{d , l} , {P}_{it}^{d , u}$$

respectively represent minimum and maximum battery discharging rate limits at location i at time t. In this case, the ISO simulator 216 may be used to solve the economic dispatch problem to minimize the total generation cost in the power network subject to constraints defined by the

$${P}_{it}^{c , l} , {P}_{it}^{c , u} and {P}_{it}^{d , l} , {P}_{it}^{d , u} ,$$

as expressed in equation (7).

By solving the economic dispatch problem, the ISO simulator 216 may be used to compute the dual variables to equations (2), (3), which are respectively denoted by λ₀ and π⁺, π⁺. As stated above, equation (2) represents a constraint defined by a power balance and equation (3) represents a constraint defined by line power flow limits. Having computed the dual variables λ₀, π⁺, π⁻, the LMP 220 can be computed as λ=λ₀+SF^{T} (π⁺−π⁻), where SF^{T} is the transpose of the matrix SF, and λ is a vector representing the locational marginal price at multiple locations (nodes) of the power network.

The BESS owner simulator 218 may use the LMP 220 computed via the ISO simulator 216 as input to solve a BESS scheduling problem to minimize a generation cost associated with the BESS, to therefrom compute the bidding parameters 222 associated with the BESS. The BESS scheduling problem may be simplified as follows:

$$min {\sum }_{t} {λ}_{t} ( {p}_{it}^{c} - {p}_{it}^{d} ) \qquad ( 8 )$$

$$s . t . constraints in Eq . ( 4 ) ,$$

The above-described BESS scheduling problem may be solved based on constraints represented in equations (4) above. These constraints may include constraints for battery charging rate and battery discharging rate, characterized respectively by power limit coefficients κ^{c}, κ^{d} that define the inverter size. The BESS owner simulator 218 may be executed to solve the above-described BESS scheduling problem to determine a BESS charging schedule and a BESS discharging schedule at each location i, defined respectively by

$${p}_{it}^{c} and {p}_{it}^{d} .$$

By solving the BESS scheduling problem using the BESS owner simulator 218, the bidding parameters 222 may be determined as {α^{c}, α^{d}, p^{c(d),I(u)}}=π̅(λ,θ), where λ is the LMP, θ is a parameter representing the BESS charging and discharging schedules

$${p}_{it}^{c} , {p}_{it}^{d} ,$$

and π̅ Is a function referred to as a bidding strategy. In embodiments, the bidding strategy π̅ may include a user-defined function, which may be derived, for example, based on heuristics, existing regulations, etc.

Starting with initial values of the bidding parameters, the ISO simulator 216 and the BESS owner simulator 218 may be iteratively executed as described above, wherein the ISO simulator 216 may be updated with the bidding parameters 222 computed via the BESS owner simulator 218, and the BESS owner simulator 218 may be updated with the LMP 220 computed via the ISO simulator 216, until a convergence criterion is satisfied. In this manner, the technical challenge posed by the implicit involvement of the dual variables may be solved by breaking down the original problem into a simplified economic dispatch problem and a simplified BESS scheduling problem based on a fixed BESS configuration. The convergence criterion may include, for example, a specified number of steps of iteration, delta (difference) in the evaluation of the generation cost associated with the BESS, among others. The optimal solution 224 (given by

$${\sum }_{t} {λ}_{t} ( {p}_{it}^{c} - {p}_{it}^{d} )$$

obtained at convergence may define an “expected” generation cost associated with the BESS for the interval covered by the respective simulation subroutine 212. Expressed in a different way, the optimal solution 224 may define an expected profit associated with the BESS (as a negative of the expected generation cost).

The configuration value 226 may be determined based on the expected generation cost or expected profit associated with the BESS over the simulation horizon and a total installation cost associated with the BESS. According to the disclosed embodiments, the expected generation cost or profit associated with the BESS over the simulation horizon may be computed by summing the expected generation costs or profits 224 computed for individual intervals at level 3, which may be adjusted to current values based on applicable interest rates. The total installation cost associated with the BESS may be determined, for example, based on based on sum of a battery capacity cost ΣᵢGᵢcᵢ and an inverter size cost

$${\sum }_{i} ( {γ}_{i}^{c} {κ}^{c} + {γ}_{i}^{d} {κ}^{d} ) {c}_{i} .$$

The hyperparameter optimization engine 202 may be executed over a number of iterations to generate, at each iteration, an updated BESS configuration 204, by tuning the hyperparameters 206, 208 based on the configuration values 226 of previous BESS configurations 204. The iterations may be performed until convergence is reached. Convergence of the hyperparameter optimization engine 202 may be determined based on satisfying one or multiple criteria, including, total CPU time spent, number of configurations explored, delta (difference) in the evaluation of the objective function, among others. Upon convergence, a final BESS configuration 204 may be determined, which is defined by a set of optimal location and sizing parameters 206, 208.

The disclosed methodology may be used to investigate multiple bidding strategies π̅. which may lead to different optimal BESS location and sizing parameters. The final configuration may be used to physically install new BESS at one or more locations in the power network based on the set of optimal location and sizing parameters.

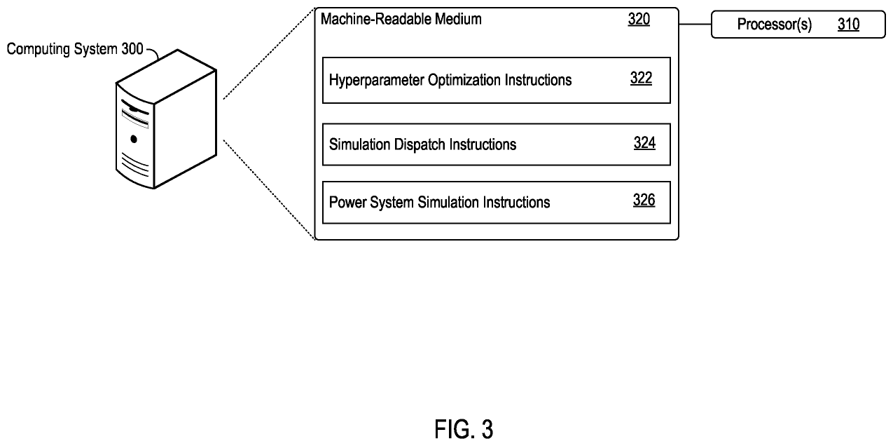

FIG. 3 shows an example of a computing system 300 that can support installation of large-scale BESS in a power network according to disclosed embodiments. The computing system 300 includes at least one processor 310, which may take the form of a single or multiple processors. The processor(s) 310 may include a one or more CPUs, GPUs, microprocessors, or any hardware devices suitable for executing instructions stored on a memory comprising a machine-readable medium. The computing system 300 further includes a machine-readable medium 320. The machine-readable medium 320 may take the form of any non-transitory electronic, magnetic, optical, or other physical storage device that stores executable instructions, such as hyperparameter optimization instructions 322, simulation dispatch instructions 324 and power system simulation instructions 326, as shown in FIG. 3. As such, the machine-readable medium 320 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 300 may execute instructions stored on the machine-readable medium 320 through the processor(s) 310. Executing the instructions (e.g., the hyperparameter optimization instructions 322, the simulation dispatch instructions 324 and the power system simulation instructions 326) may cause the computing system 300 to perform any of the technical features described herein, including according to any of the features of the hyperparameter optimization engine 202, the simulation dispatch engine 210 and the power system simulation engine 214, described above.

The systems, methods, devices, and logic described above, including the hyperparameter optimization engine 202, the simulation dispatch engine 210 and the power system simulation engine 214, may be implemented in many different ways in many different combinations of hardware, logic, circuitry, and executable instructions stored on a machine-readable medium. For example, these engines may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the hyperparameter optimization engine 202, the simulation dispatch engine 210 and the power system simulation engine 214. Computer readable program instructions described herein can be downloaded to respective computing/processing devices from a computer readable storage medium or to an external computer or external storage device via a network, for example, the Internet, a local area network, a wide area network and/or a wireless network.

The processing capability of the systems, devices, and engines described herein, including the hyperparameter optimization engine 202, the simulation dispatch engine 210 and the power system simulation engine 214, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

Although this disclosure has been described with reference to particular embodiments, it is to be understood that the embodiments and variations shown and described herein are for illustration purposes only. Modifications to the current design may be implemented by those skilled in the art, without departing from the scope of the patent claims.

1. A computer-implemented method to support installation of new battery energy storage systems (BESS) in a power network, comprising:
executing a hyperparameter optimization engine for generating a feasible configuration of BESS defined by a set of location and sizing parameters subject to an installation constraint,
executing a power system simulation engine for simulating an energy market for the power network with the generated configuration over a defined simulation horizon to determine a configuration value, by:
via a first simulator, solving an economic dispatch problem to minimize a total generation cost in the power network using bidding parameters associated with the BESS computed via a second simulator, to therefrom compute a locational marginal price (LMP) of the energy market,
via a second simulator, solving a BESS scheduling problem to minimize a generation cost associated with the BESS using the LMP computed via the first simulator, to therefrom compute the bidding parameters associated with the BESS,
iteratively updating the first simulator with the bidding parameters computed via the second simulator and updating the second simulator with the LMP computed via the first simulator to converge on an expected generation cost associated with the BESS, and
determining the configuration value based on the expected generation cost associated with the BESS and a total installation cost associated with the BESS,
wherein the hyperparameter optimization engine is executed over a number of iterations to generate, at each iteration, an updated configuration based on the configuration values of previous configurations, to determine a final configuration of BESS defined by a set of optimal location and sizing parameters.

2. The method according to claim 1, wherein the location parameters are defined by nodes of the power network.

3. The method according to claim 1, wherein the sizing parameters include battery size of the BESS defined by battery capacity.

4. The method according to claim 1, wherein the sizing parameters include inverter size of the BESS.

5. The method according to claim 4,
wherein the inverter size defined by a first coefficient indicative of a ratio between a battery charging power limit and battery capacity and a second coefficient indicative of a ratio between a battery discharging power limit and battery capacity,
wherein second simulator is utilized to solve the BESS scheduling problem to minimize the generation cost associated with the BESS subject to constraints for battery charging rate and battery discharging rate defined respectively by the first and second coefficients.

6. The method according to claim 1, wherein the installation constraint includes a maximum total installation cost associated with the BESS.

7. The method according to claim 1, wherein the hyperparameter optimization engine comprises a Bayesian optimization engine.

8. The method according to claim 1,
wherein the first simulator is utilized to solve the economic dispatch problem to minimize the total generation cost in the power network subject to a first constraint defined by a power balance and a second constraint defined by line power flow limits,
wherein the LMP is computed by computing dual variables to the relationships defining the first and second constraints.

9. The method according to claim 1, wherein the bidding parameters are determined as a function of the LMP computed via the first simulator and charging and discharging schedules of the BESS computed via the second simulator to minimize the generation cost associated with the BESS.

10. The method according to claim 1,
wherein the bidding parameters computed via the second simulator comprise a charging cost per unit of power and a discharging cost per unit of power for respective locations of the BESS,
wherein the total generation cost in the power network minimized via the first simulator is determined using the charging cost per unit of power and the discharging cost per unit of power for respective locations of the BESS.

11. The method according to claim 10,
wherein the bidding parameters computed via the second simulator further comprise maximum and minimum charging rate limits and maximum and minimum discharging rate limits of respective BESS,
wherein the first simulator is utilized to solve the economic dispatch problem to minimize the total generation cost in the power network subject to constraints defined by the
the charging rate limits and discharging rate limits.

12. The method according to claim 1, wherein the total installation cost associated with the BESS is determined based on sum of a battery capacity cost and an inverter size cost.

13. The method according to claim 1, further comprising:
executing a simulation dispatch engine for decomposing the simulation horizon into a number of intervals to generate simulation subroutines corresponding to the respective intervals,
wherein the subroutines are independently processed in parallel via the simulation engine to determine an expected generation cost associated with the BESS for each interval, to therefrom determine the configuration value over the simulation horizon.

14. A non-transitory computer-readable storage medium including instructions that, when processed by a computing system, configure the computing system to perform the method according to claim 1.

15. A system to support installation of new battery energy storage systems (BESS) in a power network, comprising:
one or more processors, and
memory storing algorithmic modules executable by the one or more processors, the algorithmic modules comprising:
a hyperparameter optimization engine configured to generate a feasible configuration defined by a set of location and sizing parameters of the BESS subject to an installation constraint, and
a power system simulation engine configured to simulate an energy market for the power network with the generated configuration over a defined simulation horizon to determine a configuration value, the power system simulation engine comprising:
a first simulator configured to solve economic dispatch problem to minimize a total generation cost in the power network using bidding parameters associated with the BESS computed via a second simulator, to therefrom compute a locational marginal price (LMP) of the energy market, and
a second simulator configured to solve a BESS scheduling problem to minimize a generation cost associated with the BESS using the LMP computed via the first simulator, to therefrom compute the bidding parameters associated with the BESS,
wherein the first and second simulators are executable iteratively to update the first simulator with the bidding parameters computed via the second simulator and update the second simulator with the LMP computed via the first simulator to converge on an expected generation cost associated with the BESS,
wherein the configuration value is determined based on the expected generation cost associated with the BESS and a total installation cost associated with the BESS, and
wherein the hyperparameter optimization engine executable over a number of iterations to generate, at each iteration, an updated configuration based on the configuration values of previous configurations, to determine a final configuration defined by a set of optimal location and sizing parameters of BESS.

16. The system according to claim 15, wherein the algorithmic modules further comprise a simulation dispatch engine configured to decompose the simulation horizon into a number of intervals to generate simulation subroutines corresponding to the respective intervals, wherein the subroutines are independently processed in parallel via the simulation engine to determine an expected generation cost associated with the BESS for each interval, to therefrom determine the configuration value over the horizon.
